(19) United States
(12) Patent Application Publication
(10) Pub. No.: US 2025/0208663 A1
(43) Pub. Date: Jun. 26, 2025

(54) Fabric Hinged Device

(71) Applicant: Microsoft Technology Licensing, LLC, Redmond, WA (US)

(72) Inventors: Oluwatomi Osamuede AKIN-SODIPO, Seattle, WA (US); Karthika POONAMMALLEE VENKATASUBRA, Redmond, WA (US); Ishmael ADAMS, Redmond, WA (US); Charles Albert PRESCOTT, Seattle, WA (US); Ryan LAPRISE, Redmond, WA (US); Andrew Flury THOMPSON, Redmond, WA (US)

(73) Assignee: Microsoft Technology Licensing, LLC, Redmond, WA (US)

(21) Appl. No.: 18/393,315

(22) Filed: Dec. 21, 2023

(51) Int. Cl. G06F 1/16

(52) U.S. Cl. CPC G06F 1/1681

(57) ABSTRACT

This patent relates to hinged devices, such as computing devices. One example includes a first portion including a first input/output device and a second portion including a second input/output device. A hinge assembly includes a flexible hinge that removably couples the first and second portions and allows relative rotation between the first and second portions. The flexible hinge is biased into the first portion to reduce a percentage of the flexible hinge exposed between the first and second portions at a given rotational or angular orientation of the first and second portions.

### BACKGROUND

Many computer form-factors, such as smart phones, tablets, and notebook computers can provide enhanced functionality by folding for storage and opening for use and/or by folding into various configurations. For instance, the folded device is easier to carry and the opened device offers more input/output area.

### SUMMARY

This patent relates to hinged devices, such as computing devices. One example includes a first portion including a first input/output device and a second portion including a second input/output device. A hinge assembly includes a flexible hinge that removably couples the first and second portions and allows relative rotation between the first and second portions. The flexible hinge is biased into the first portion to reduce a percentage of the flexible hinge exposed between the first and second portions at a given rotational or angular orientation of the first and second portions.

This example is intended to provide a summary of some of the described concepts and is not intended to be inclusive or limiting.

### BRIEF DESCRIPTION OF THE DRA WINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced. Note that some figures illustrate many elements and adding lead lines to all of the elements can diminish readability of the figure. Accordingly, not every element is designated in every figure.

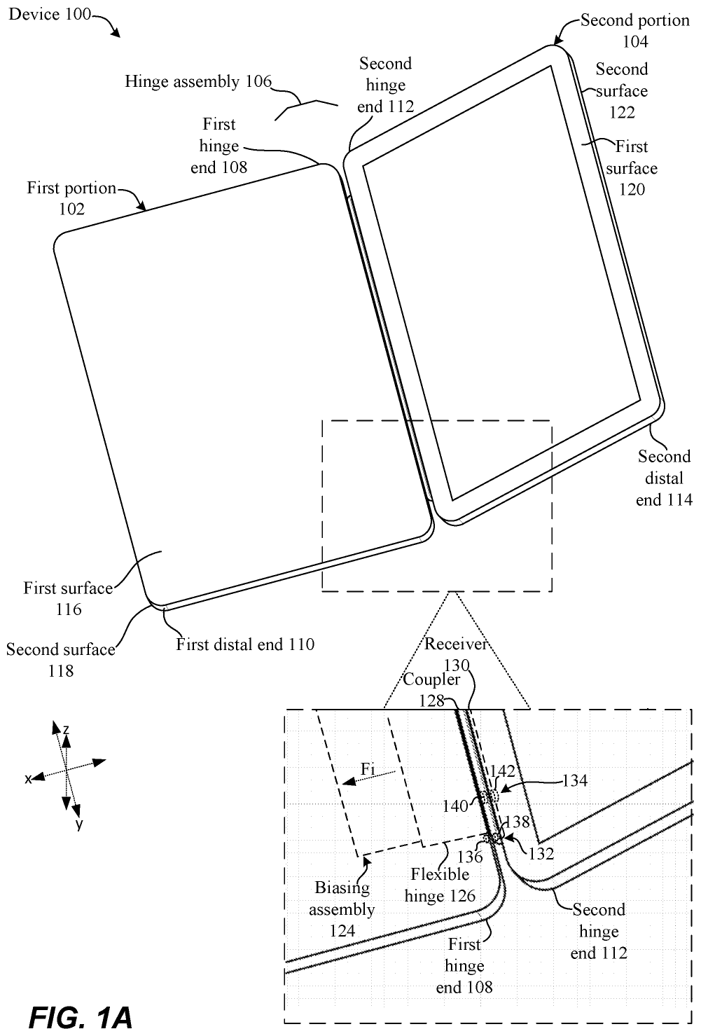

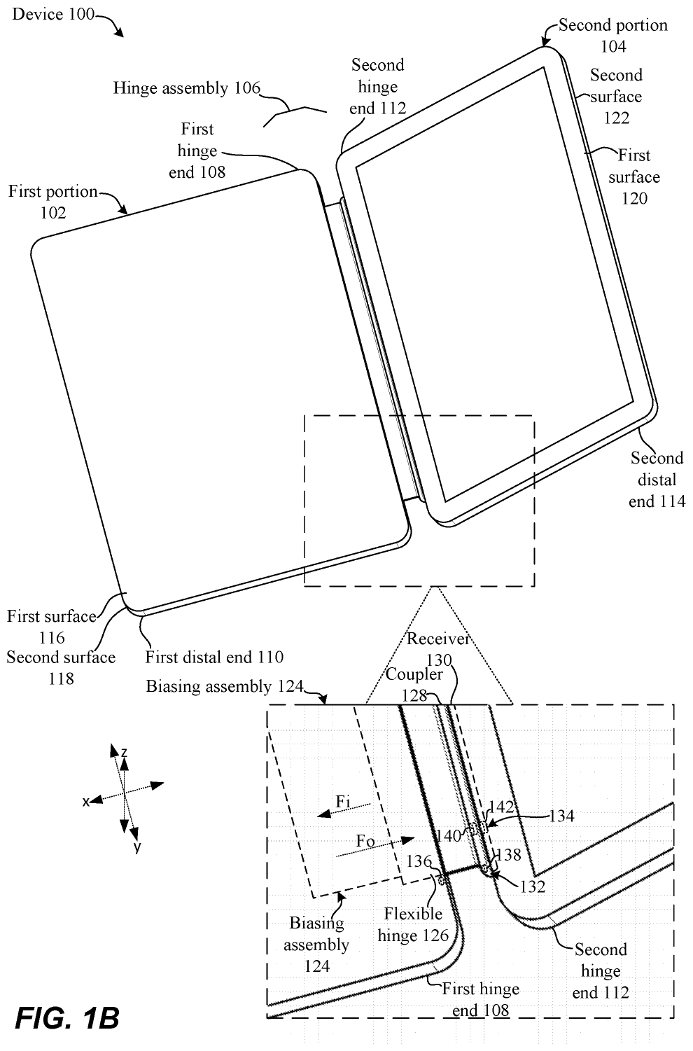

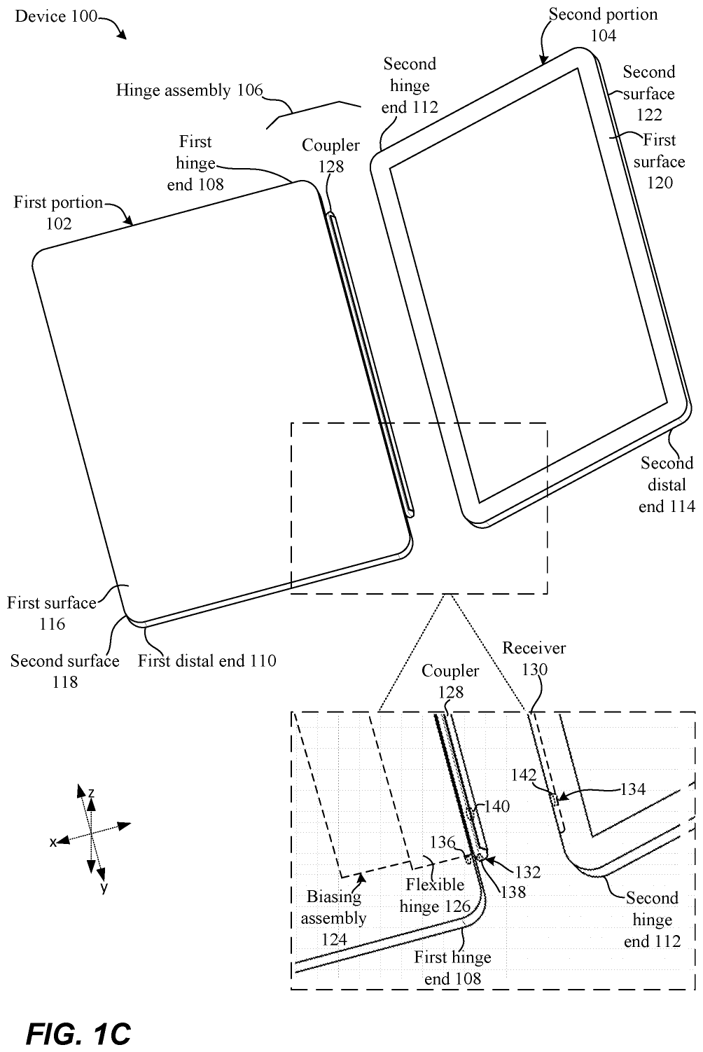

FIGS. 1A, 1B, 1C, 2A, 3A, 4A, 5A, 6A, 6B, 7A, 7B, 8A, 8B, 9A, and 9B show perspective views of example devices in accordance with some implementations of the present concepts.

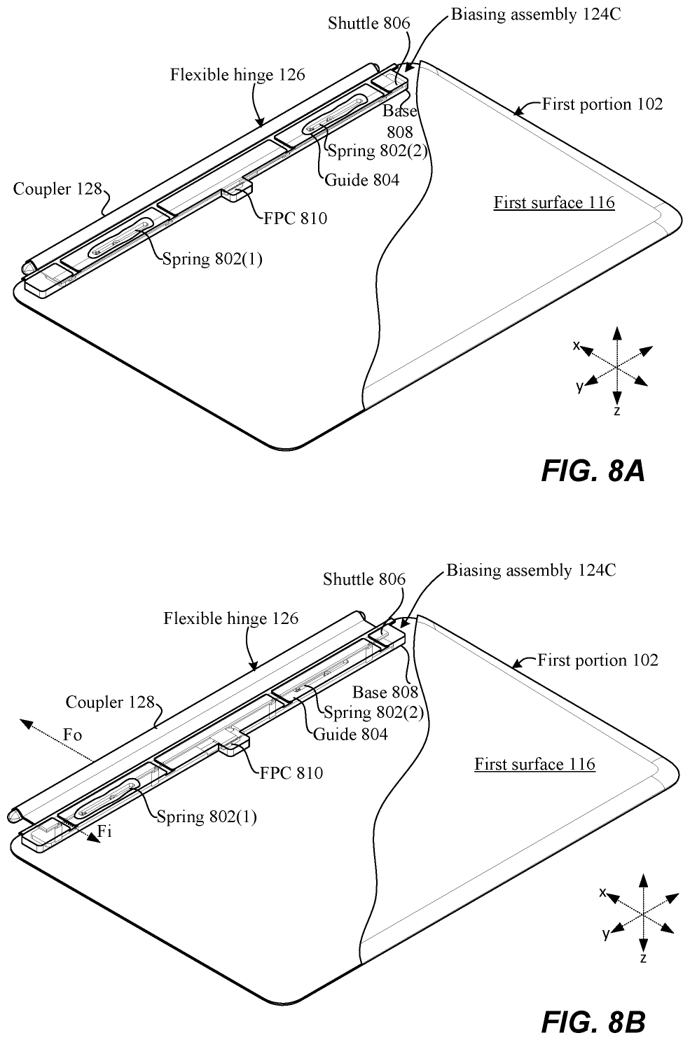

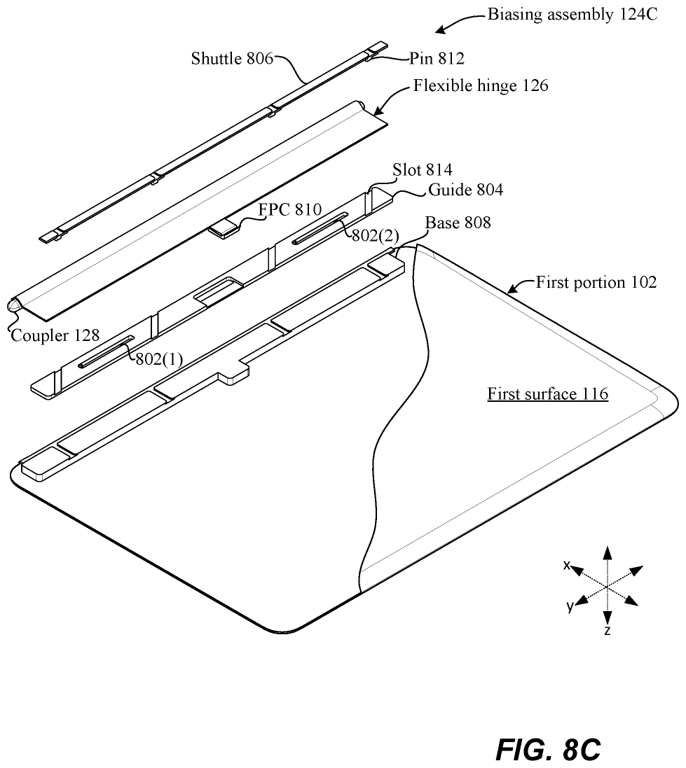

FIG. 8C shows an exploded perspective view of an example device in accordance with some implementations of the present concepts.

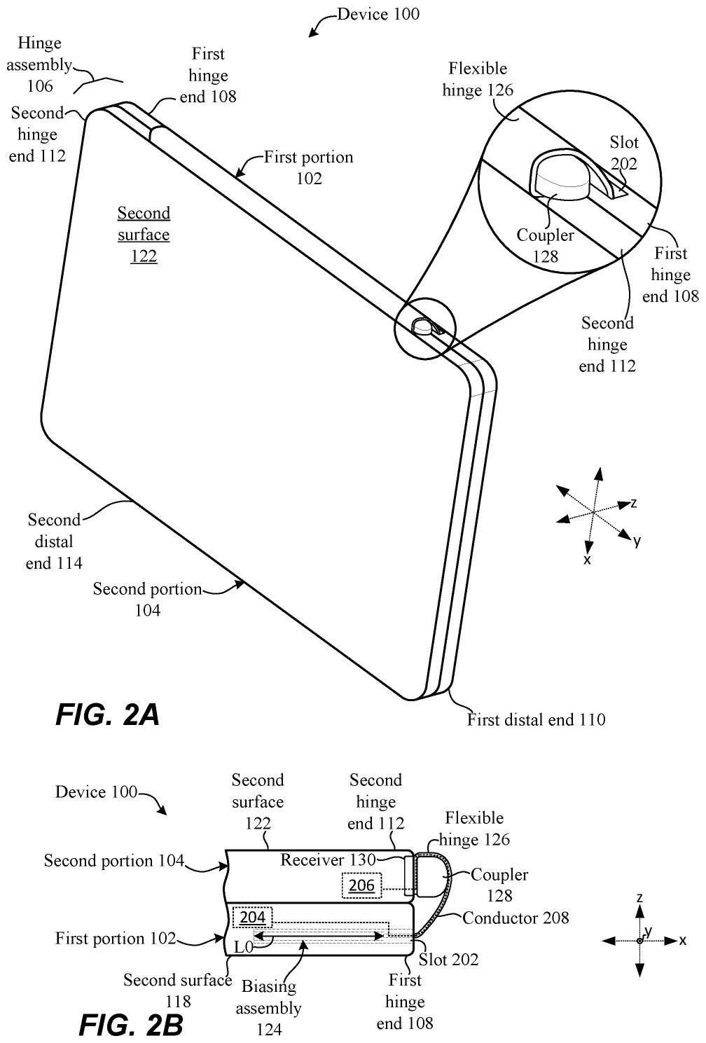

FIGS. 2B, 3B, 4B, and 5B show elevational views of example devices in accordance with some implementations of the present concepts.

### DESCRIPTION

The present concepts relate to devices, such as computing devices employing flexible hinges that are biased toward a retracted position but can be extended when subjected to an external force. Flexible hinges have been employed before to rotationally couple device portions through a range of angular orientations. However, a length of a path of the flexible hinge changes with different angular orientations. As result, traditional flexible hinges were long enough to accommodate the longest path length associated with the any of the angular orientations. This resulted in extra flexible hinge length (e.g., material) at other angular orientations. This extra flexible hinge material can diminish device function. For instance, the extra flexible hinge material can obscure portions of the device. In contrast, the present concepts provide a flexible hinge that is internally biased (e.g., retracted) into the first portion to ensure there is no extra hinge material between the first and second portions of the device. As the angular orientation changes, external forces created by the hinge ends of the device portions can overcome the internal bias force to pull out sufficient hinge material. The internal bias continues to be exerted on the flexible hinge material and can retract additional hinge material as dictated by the pathlength defined by the angular orientation of the first and second portions.

The present concepts provide a technical solution that ensures that extra flexible hinge length does not diminish the user experience, such as by blocking portions of the display. This technical solution ensures that the length of the exposed portion of the flexible hinge matches the pathlength between the first and second portions. The remainder of the flexible hinge is biased into the first portion of the device. This technical solution can enhance use of the device real estate, such as by allowing a smaller bezel and hence a larger display because extra hinge material that could block the display is eliminated.

Existing flexible hinge designs tend to be floppy and allow relative movements between the flexible hinge and the device portions. This diminishes the user experience. For instance, this floppiness can make it more difficult for the user to reconnect the device portions after separation. Further, the floppiness can be distracting during user engagement, such as typing. The present concepts provide a technical solution that secures the flexible hinge between the first and second portions and reduces or eliminates the relative movement. This technical solution also allows the device portions to be thinner yet have a more robust user feel due to the integrity between the device portions and the flexible hinge. These and other aspects are described below.

Introductory FIGS. 1A-1C collectively show an example device 100 that includes first and second portions 102 and 104 that are coupled by a hinge assembly 106. The hinge assembly 106 allows the first and second portions to rotate relative to one another through a range of angular orientations, such as from a closed angular orientation to a fully opened angular orientation. The first portion 102 can include a first hinge end 108 and a first distal end 110. Similarly, the second portion 104 can include a second hinge end 112 and a second distal end 114. The first portion 102 defines opposing spaced-apart first and second surfaces 116 and 118 and the second portion 104 defines opposing spaced-apart first and second surfaces 120 and 122. To avoid confusion, first surface 120 could also be viewed as the “third surface” and second surface 122 could be viewed as the “fourth surface.”

The hinge assembly 106 includes a biasing assembly 124 and a flexible hinge 126. The flexible hinge 126 terminates in a coupler 128 that removably engages a receiver 130 defined by the second portion 104. The biasing assembly 124 is positioned between the first and second surfaces 116 and 118. The biasing assembly 124 is secured to the flexible hinge 126 and to the first portion 102. The flexible hinge 126 is positioned between the first and second surfaces 116 and 118 and extends out of the first hinge end 108 and terminates at the coupler 128, which is outside (e.g., external to) the first portion 102. The flexible hinge 126 can extend along a majority of the first hinge end 108 of the first portion as measured in the y reference direction. In some of these implementations, the flexible hinge extends along about 75% to % 100 percent of the first hinge end 108 (e.g., a width of the flexible hinge is slightly less than a width of the first hinge end 108 of the first portion 102).

In this implementation, the device 100 also includes a stability mechanism 132 and a retention mechanism 134. In this example, the stability mechanism 132 is manifest as pairs of magnets 136 and 138 positioned on the distal ends of the first hinge end 108 and the coupler 128. The pairs of magnets 136 and 138 align the coupler 128 with the first hinge end 108. The alignment can maintain the coupler 128 between the first and second surfaces 116 and 118 of the first portion 102 when the first and second portions 102 and 104 are physically separated from one another as shown in FIG. 1C. This maintenance of the coupler 128 can facilitate recoupling the first and second portions by holding the coupler 128 against the first hinge end 108 of the first portion 102 and pointing outward to facilitate coupling with the receiver 130 when the first and second portions are positioned proximate to one another by the user.

When the first and second portions 102 and 104 are coupled together by the coupler 128 and the receiver 130, the pairs of magnets 136 and 138 can prevent relative movement of the first hinge end 108 of the first portion relative to the coupler 128 and the second portion 104. For instance, such movement can include side-to-side rocking when the user is engaging the first portion, such as when the user is typing on the first portion. This relative movement can also include deformation of portions of the hinge end when engaged by a user. Stated another way, deformation of the first hinge end from forces associated with user engagement is reduced by the stability mechanism 132 and/or the retention mechanism 134. For instance, if the first portion 102 and the first hinge end 108 have a generally planar configuration, the stability mechanism 132 and the retention mechanism 134 reduce deformation from the planar configuration when the user engages the device 100, such as by holding the device and/or typing on the device.

The retention mechanism 134 is manifest as pairs of magnets 140 and 142 positioned in the coupler 128 and the receiver 130, respectively. The pairs of magnets 140 and 142 can draw the coupler and receiver together and provide precise alignment and mechanical coupling as the user positions them toward one another. Once engaged, the pairs of magnets 140 and 142 can provide a retention force between the coupler 128 and receiver 130 (e.g., mechanical coupling) so that they do not come apart unless the user forcibly pulls them apart as shown in FIG. 1C. This retention force can work cooperatively with the stability offered by the stability mechanism 132 as a technical solution to create stability between the first portion 102, the hinge assembly 106, and the second portion 104 to enhance user engagement, such as carrying the device by holding only the first portion 102 or the second portion 104 or when engaging input devices on the first portion or the second portion.

The biasing assembly 124 imparts a bias force Fi on the flexible hinge 126 into the first portion (e.g., in the −x reference direction). As shown in FIG. 1A, under some conditions (e.g., at some angular orientations) the biasing force Fi (force inward) can pull the flexible hinge 126 into the first portion until the coupler 128 is against the first hinge end 108 of the first portion 102. At this point, the coupler 128 stops further movement of the flexible hinge 126 into the first portion 102.

FIG. 1B shows an outward force Fo overcoming the biasing force Fi to extend (e.g., pull) the flexible hinge 126 part way out of the first portion. Retention forces between the magnets 140 and 142 is large enough that as the device portions are separated, the coupler 128 stays engaged with the receiver 130 while the extent of the flexible hinge external to the first portion 102 increases (e.g., the flexible hinge 126 is extended). This extension can occur when a user pulls the first and second portions apart to separate them. This extension can also occur as the first and second portions are rotated to various angular orientations. The biasing assembly 124 provides a technical solution that creates biasing force Fi on the flexible hinge 126 from the first hinge end 108 toward the first distal end 110 and an extent of the flexible hinge exposed at the first hinge end 108 is determined by an angular orientation of the first and second portions. This aspect is described in more detail below relative to FIGS. 2A-5B.

FIG. 1C shows the first and second portions 102 and 104 separated from one another. This separation can occur when forces pulling the first and second portions apart, such as exerted by a user is greater than the retention forces between the magnets 140 and 142 and the coupler 128 is separated from the receiver 130. Once separation occurs, the biasing force Fi biases the flexible hinge 126 back into the first portion until the coupler 128 contacts the first hinge end 108, which stops further inward movement.

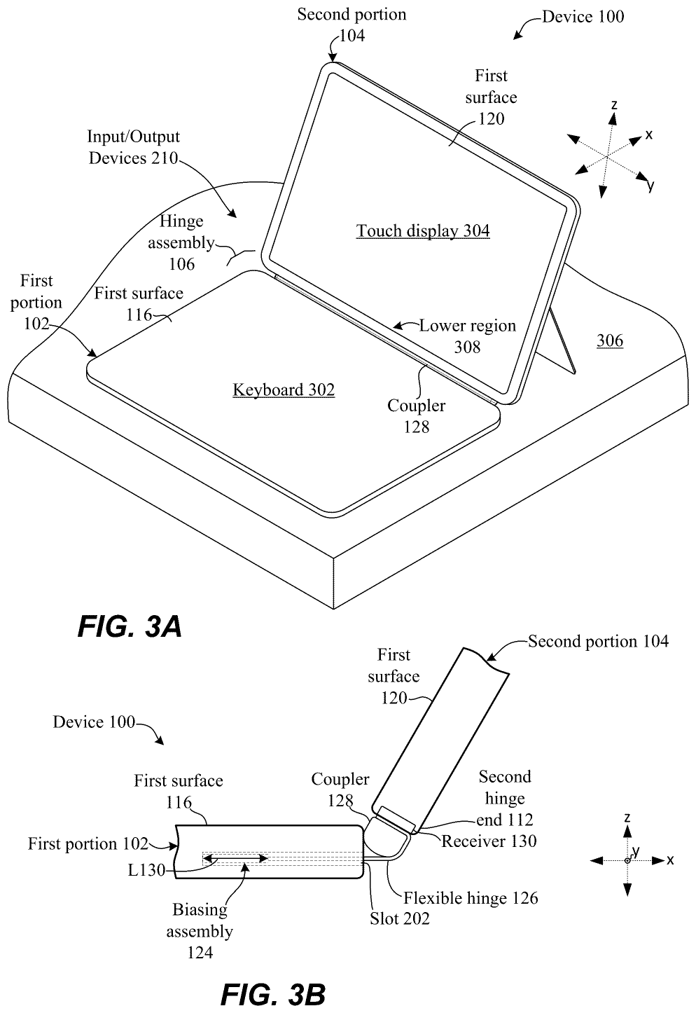

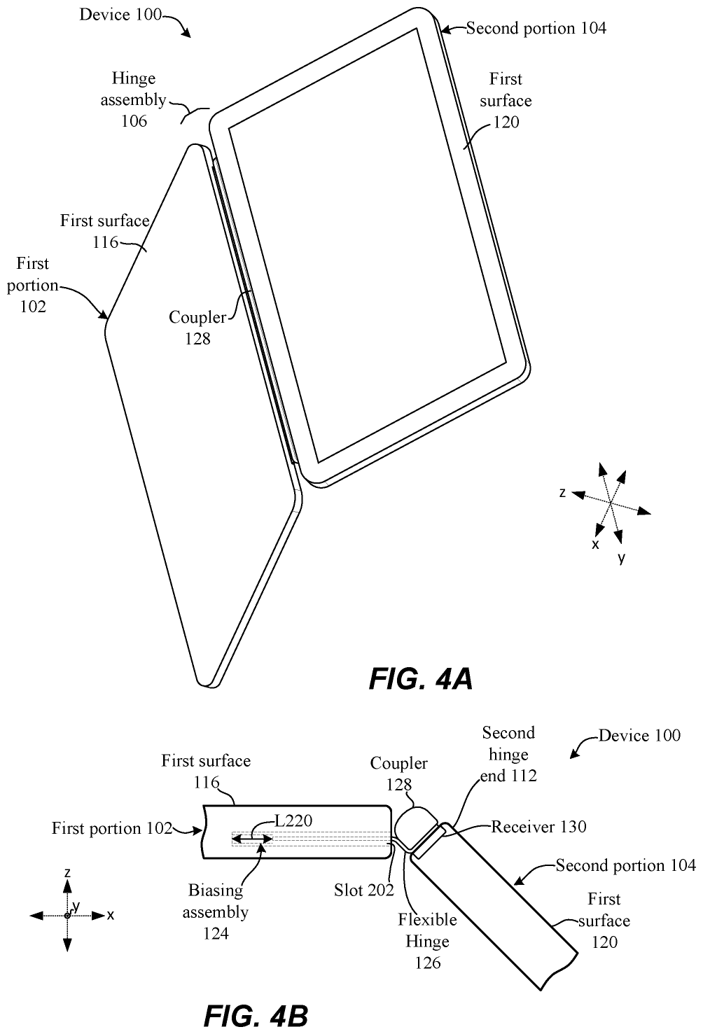

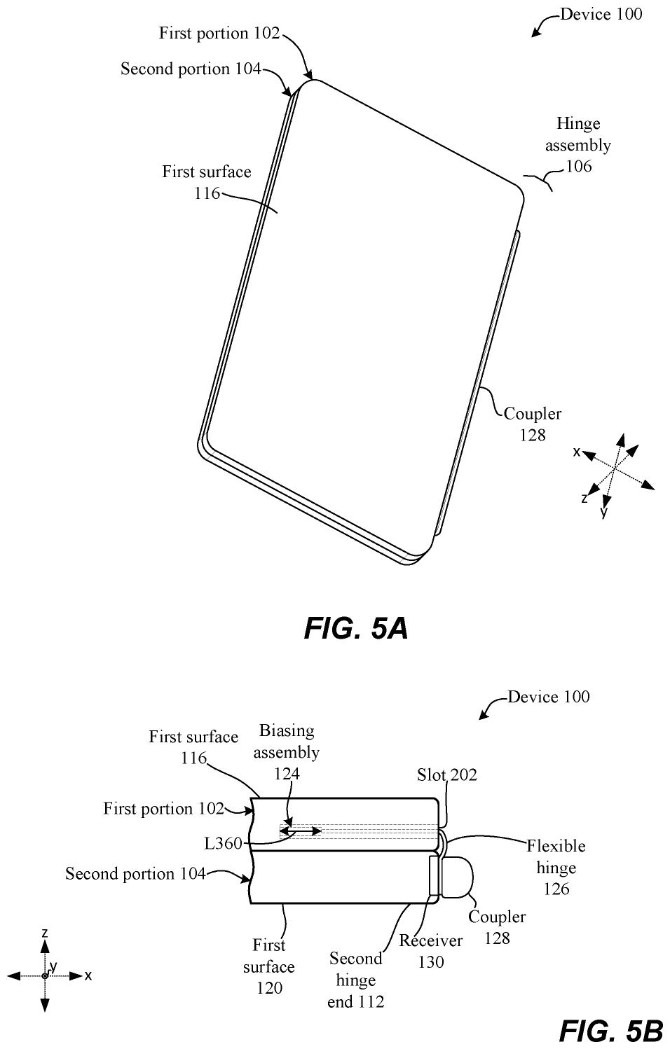

FIGS. 2A-5B collectively show additional features of example hinge assembly 106. FIGS. 2A and 2B show device 100 with the first and second portions positioned against one another in a zero-degree or closed angular orientation. FIGS. 3A and 3B show device 100 with the first and second portions positioned against one another in an approximately 130-degree angular orientation. FIGS. 4A and 4B show device 100 with the first and second portions positioned against one another in an approximately 220-degree angular orientation. FIGS. 5A and 5B show device 100 with the first and second portions in a fully open angular orientation, which in this case entails an approximately 360-degree angular orientation.

These FIGS. show a slot 202 defined in the first hinge end 108 of the first portion 102. The flexible hinge 126 emerges from the slot 202 and terminates at coupler 128.

FIGS. 2A and 2B show the device with the first and second portions 102 and 104 closed against one another at a zero-degree angular orientation. In the zero-degree angular orientation, the first surfaces (116 and 120, labelled on FIG. 3A) are positioned against one another and the second surfaces 118 and 122 are facing away from one another. At this angular orientation, the path of the flexible hinge from the first portion to the second portion is relatively long. As a result, the bias force of the biasing assembly 124 on the flexible hinge 126 into the first portion 102 is partially overcome and a relatively larger proportion of the flexible hinge 126 is pulled out of the first portion (e.g., out of the slot 202) and is exposed at the hinge ends 108 and 112. This aspect can be visualized in that the length LO of the biasing assembly 124 is greater at this angular orientation than at the other shown angular orientations. The longer length LO allows more of the flexible hinge 126 to be extended or pulled out of the first portion and extends between the first and second portions. Note that the flexible hinge can be relatively inelastic and not stretch significantly during this process. Instead, the extent or percentage of the flexible hinge that is external to the first portion 102 is determined by the length L of the biasing assembly 124. Thus, the extent of the flexible hinge 126 that is external to the first portion is inversely proportional to the length L of the biasing assembly 124.

Note that the inward bias created by the biasing assembly 124 maintains tension on the flexible hinge 126 and thus no extra flexible hinge length is external to the first portion (e.g., exposed). Instead, the exposed portion of the flexible hinge 124 (e.g., that is external to the first portion) is equivalent to the path length of the flexible hinge at this angular orientation. As can be seen by comparing FIGS. 2B, 3B, 4B, and 5B as the pathlength of the flexible hinge changes with the angular orientation of the first and second portions, the length of the flexible hinge that is external to the first portion changes accordingly and no surplus flexible hinge material is outside the first portion at a particular angular orientation.

FIG. 2B also shows electronic components 204 and 206 positioned in the first and second portions 102 and 104, respectively. The flexible hinge 126 can include electrical conductors 208 that electrically couple the electronic components 204 and 206. The electrical conductors 208 can include removable junctions between the coupler 128 and the receiver 130. Thus, the coupler 128 and the receiver 130 provide both mechanical and electrical coupling between the first and second portions. The electronic components 204 and 206 and the electrical conductors 208 are not shown in the other FIGS. to reduce clutter on the drawing pages. However, the electronic components can include processors, batteries, and/or input/output devices 210. Example input/output devices 210 are shown on first surfaces 116 and 120 on FIG. 3A.

FIGS. 3A and 3B show the first and second portions 102 and 104 rotated to a common notebook style user angle of approximately 130 degrees. The input/output devices 210 are manifest as a keyboard 302 on first surface 116 and a touch display 304 on first surface 120. Other configurations are contemplated, such as displays, non-touch and/or touch, positioned on both first surfaces 116 and 120 and second surfaces 118 and 122, among other configurations.

Recall that the stability mechanism 132 described and illustrated relative to FIGS. 1A-1C biases the coupler 128 against the first portion 102. The stability mechanism 132 prevents or constrains movement (e.g. in the z reference direction) between the coupler 128 and the first portion 102 when the user engages the first portion, such as by using the keyboard 302. The constrained movement can include relative vertical movement (e.g. in the z reference direction), rotational movement along the x reference direction, and/or deformation (e.g., changes in the shape), among others, when the user engages the first portion.

FIG. 3A shows the device 100 positioned on a horizontal reference surface 306, such as a tabletop. In this case, the hinge assembly 106 employing the flexible hinge 126 and the biasing assembly 124 ensures that extra hinge material is not external to the first portion 102, instead, the biasing assembly 124 biases the flexible hinge 126 into the first portion until stopped by contact between the coupler 128 and the first hinge end 108. This configuration provides a technical solution that allows the entire length of the first portion 102 in the x reference direction (e.g., the entire second surface 118) to contact the horizontal reference surface 306. This configuration reduces bounce, flexing, and/or rotation of the first portion when engaged by the user. This aspect can be even more pronounced on uneven reference surfaces, such as if the user places the device on their lap (e.g., knees/thighs). The integrity provided by the biasing assembly 124 biasing the flexible hinge 126 into the first portion and the stability mechanism (132, FIGS. 1A-1C) stabilizing the coupler 128 relative to the first portion, decreases relative movement and enhances the user experience.

The integrity of this configuration maintains a planar configuration of the first portion 102. The bias or tension provided to the flexible hinge 126 by the biasing assembly 124 ensures that extra hinge material does not extend upwardly between the first and second portions 102 and 104. This extra material creates a floppy feeling when the user types on the keyboard and/or obscures lower regions 308 of the touch display 304 on the second portion 104. Thus, the present concepts provide a technical advantage over existing flexible hinge designs where extra hinge material is folded in certain angular orientations of the device. This folded hinge material can obscure lower region 308 of the second portion. For instance, in relation to touch display 304, the folding may block some of the pixels and/or require a wider bezel so that the display does not extend as close to the hinge assembly. The present concepts control the extent that the flexible hinge extends out of the first portion with an inward bias. This inward bias keeps the flexible hinge taut and eliminates hinge material folding and/or associated blockage of the display on the second portion by the flexible hinge.

FIGS. 4A and 4B show the first and second portions rotated further to about 220 degrees. At this point a majority of the flexible hinge is being pulled into the first portion 102 as the biasing assembly 124 shortens. This shortening is evident in that biasing assembly length L220 is less than length L130 of FIGS. 3A and 3B. Thus, the extent of the flexible hinge 126 that is external to the first portion 102 is reduced compared to the zero-degree orientation and the 130-degree orientation. This reduction ensures that only enough flexible hinge length is extended out of the first portion to match the hinge path.

FIGS. 5A and 5B show the first and second portions 102 and 104 rotated further to a 360-degree angular orientation. At this angular orientation, the first surfaces 116 and 120 are facing outwardly and the second surfaces 118 and 122 are positioned against one another. The biasing assembly 124 has contracted to length L360 which is similar to length L220 of FIGS. 4A and 4B and shorter than lengths L130 and LO. Thus, the extent of flexible hinge 126 that is external to the first portion 102 is less than at the zero-degree and 130 degree orientations. At the 220-degree and 360-degree orientations, the exposed percentage of the flexible hinge 126 is at or near its minimum and the remainder of the flexible hinge is biased into the internal regions of the first portion 102.

These representative angular orientations illustrate that the combination of the flexible hinge 126 and the biasing assembly 124 ensure that the flexible hinge can accommodate rotation between the first and second portions 102 and 104 through a range of angular orientations. At each angular orientation, the biasing assembly 124 keeps the flexible hinge under tension (e.g., biased inwardly) so that surplus portions of the flexible hinge are inside the first portion rather than being external to the first portion. This technical solution is further combined with a technical solution provided by the stability mechanism 132 and the retention mechanism 134 that enhances the operational integrity between the first portion 102 and the coupler 128 and between the coupler and the second portion 104 without increasing the thickness of the first portion as measured in the z-reference direction. Instead, the technical solutions allow a relatively thin first portion that feels robust and stable to the user and reduces/eliminates excess flexible hinge material that could otherwise obscure lower regions of the second portion and/or create a floppy overall device feel.

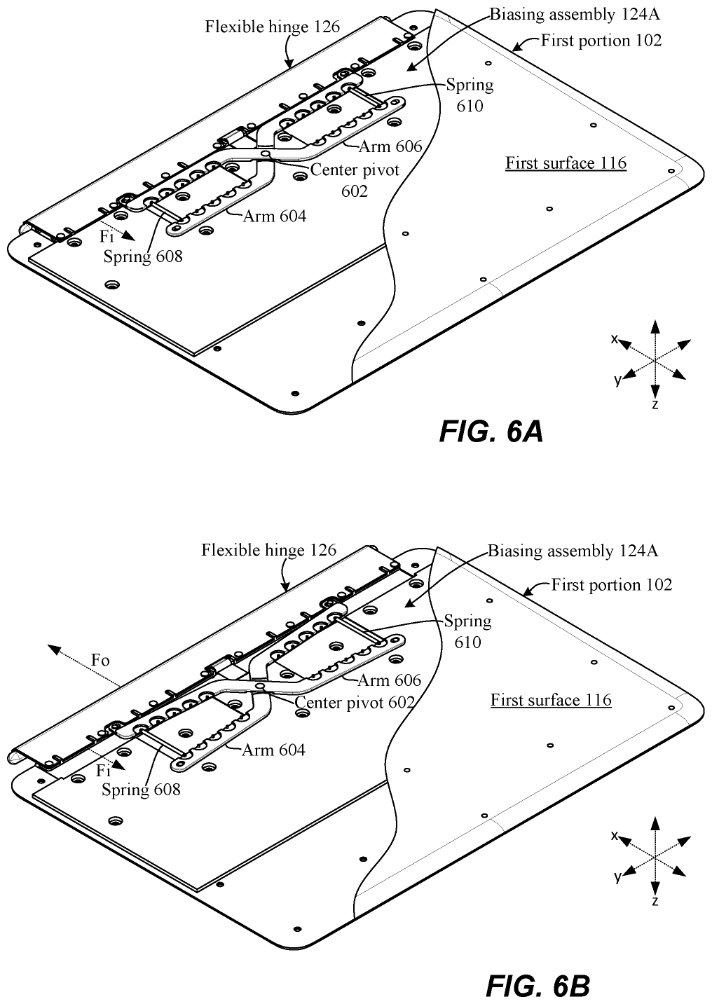

FIGS. 6A-9B collectively illustrate several example biasing assemblies 124 relative to first portion 102 and flexible hinge 126.

FIGS. 6A and 6B collectively show biasing assembly 124A in first portion 102 with first surface 116 partially cut-away to expose the biasing assembly. Biasing assembly 124A includes a center pivot 602 around which first and second arms 604 and 606 rotate in an x-shape with the center pivot centrally located. The arms 604 and 606 are biased towards one another by springs 608 and 610. Distal sides of the arms are secured to the flexible hinge 126. The springs 608 and 610 create a biasing force that is transferred to the flexible hinge by the arms 604 and 606 to create the inward force (Fi) on the hinge assembly that pulls or retracts the flexible hinge 126 into the first portion 102 as shown in the retracted position of FIG. 6A.

FIG. 6B shows an external outward force Fo acting on the flexible hinge 126 and overcoming the inward force Fi to increase a percentage of the flexible hinge 126 that is outside of the first portion 102 in the extended position. The movement of the flexible hinge stretches the springs 608 and 610. The springs maintain the inward force Fi and if the outward force Fo is reduced and/or eliminated, the inward force will pull (more of) the flexible hinge 126 back into the first portion.

The x-shaped hinge arms 604 and 606 with the center pivot 602 provides a technical solution that ensures that the flexible hinge 126 extends and retracts uniformly (e.g., the same amount of extension and retraction occurs on the left side (−y reference direction) and the right side (+y reference direction) when the flexible hinge moves in the x direction.

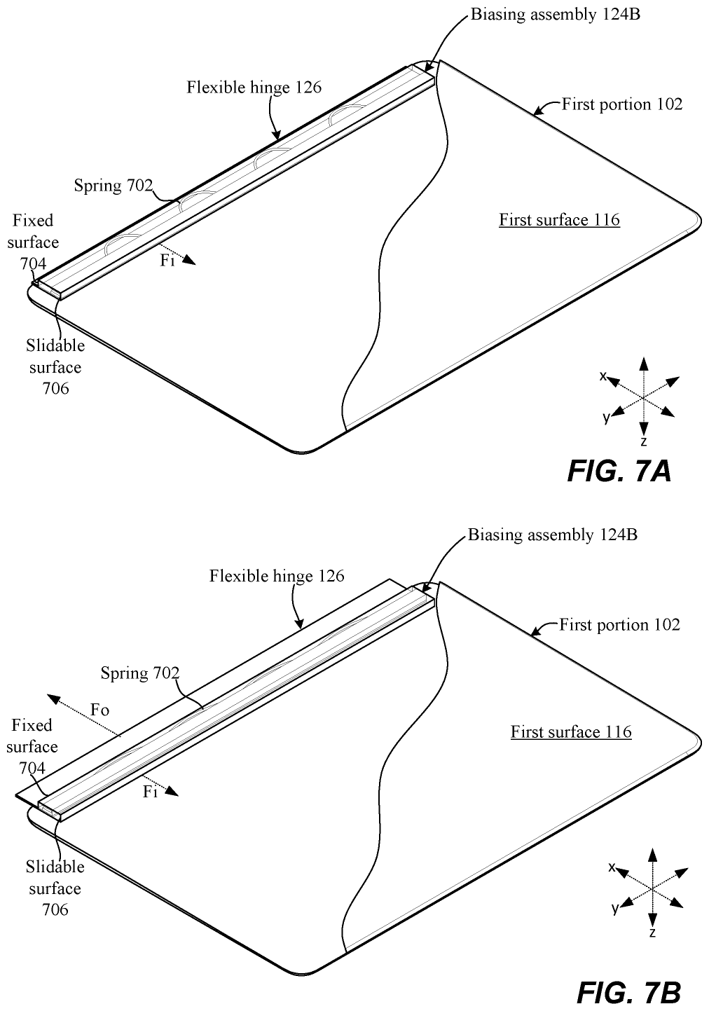

FIGS. 7A and 7B show another biasing assembly 124B in first portion 102. In this case, the biasing assembly 124B includes an elongate sinusoidal shaped coil spring 702 that is captured between a fixed surface 704 and a slidable surface 706. The slidable surface 706 is secured to the flexible hinge 126. FIG. 7A shows the spring 702 imparting forces on the two surfaces 704 and 706. Because fixed surface 704 does not move, this spring force moves slidable surface 706 inwardly and creates the inward force Fi on the flexible hinge 126. Thus, the biasing assembly 124B is biasing the flexible hinge into the retracted position.

FIG. 7B shows external outerward force Fo overcoming the inward spring force Fi and pulling the flexible hinge 126 out of the first portion 102 (e.g., increasing the percentage of the flexible hinge that is external to the first portion 102). This movement compresses the spring 702, which then maintains the inward force to keep the flexible hinge taut and to pull more of the flexible hinge back into the first portion if the outward force Fo is reduced. The elongate coil spring 702 and the fixed and slidable surfaces 704 and 706 extend along a majority of the flexible hinge in the y-reference direction. This configuration provides a technical solution that ensures that the flexible hinge extends and retracts uniformly (e.g., the same amount of extension and retraction occurs on the left side (−y reference direction) and the right side (+y reference direction) when the flexible hinge moves in the x direction).

FIGS. 8A-8C collectively show another biasing assembly 124C in first portion 102. FIG. 8A shows the flexible hinge 126 retracted by the biasing assembly 124C into the first portion 102 until the coupler 128 is stopped by the first portion 102. FIG. 8B shows the flexible hinge 126 extended out of the first portion 102. FIG. 8C shows an exploded view to allow enhanced visualization of some of the elements of the biasing assembly 124C.

In this implementation, the biasing assembly 124C includes springs 802, a guide 804, a shuttle 806, a base 808, and a flexible printed circuit (FPC) 810. The shuttle defines pins 812 which ride in slots 814 defined in the guide 804. In this case, the springs 802 are located along the long axis (e.g., y reference axis) of the flexible hinge 126. The shuttle 806 is secured to the flexible hinge 126. The pins 812 move in the slots 814 to ensure even retraction and extension of the flexible hinge along the long axis of the flexible hinge. This configuration provides a technical solution that ensures that the flexible hinge extends and retracts uniformly (e.g., the same amount of extension and retraction occurs on the left side (−y reference direction) and the right side (+y reference direction) when the flexible hinge moves in the x reference direction). Stated another way, biasing assembly 124C is configured to cause an extent of the flexible hinge 126 exposed between the first hinge end 108 and the coupler 128 at a given orientation to be generally uniform along a width of the flexible hinge 126. For instance, generally uniform means variations of less than or about 10% along the width of the flexible hinge 126.

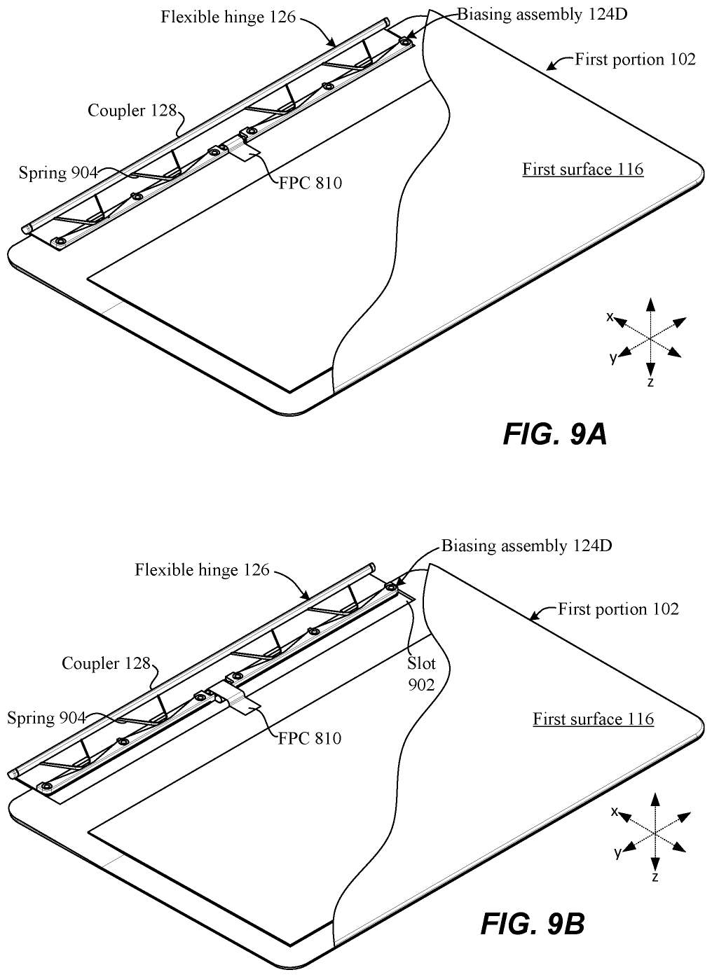

FIGS. 9A and 9B collectively show another biasing assembly 124D in first portion 102 with first surface 116 partially cut-away to expose the biasing assembly. This implementation includes a slot 902 formed in the first portion that has a width approximately equal to or slightly larger than a width of the flexible hinge 126 measured along the long axis (e.g., y reference axis). A leaf spring 904 couples the flexible hinge 126 to the first portion and applies the inward biasing force to retract the flexible hinge as shown in FIG. 9A. An external outward force can overcome the inward bias force and extend the flexible hinge 126 outwardly along a trajectory defined by the slot 902 as shown in FIG. 9B.

The device components described herein can be selected from and formed using materials and techniques employed in the art. The flexible hinge can include a material that can be selected based upon desired design properties for a given device implementation. For instance, a high fiber count woven fabric formed from high strength thread, such as Kevlar thread may be used in one implementation. High fiber count woven fabric can provide a technical solution of combining thinness with wear resistance while having desired bending/flexing properties. Another implementation may employ a polymer sheet, rather than a woven fabric, among other variations. Further, while specific form factors are illustrated for purposes of explanation, the present concepts can be applied to other hinged computer form factors, such as notebook computers, tablets, smartphones, and/or other existing or yet to be developed form factors.

Various examples are described above. Additional examples are described below. One example includes a device comprising a first portion including first and second spaced-apart surfaces extending from a first hinge end to a first distal end, a second portion including third and fourth spaced-apart surfaces extending from a second hinge end to a second distal end, a biasing assembly positioned in the first portion between the first and second spaced-apart surfaces, and a flexible hinge that rotatably secures the first and second portions through a range of angular orientations, the flexible hinge secured to the biasing assembly between the first and second spaced-apart surfaces and extending out of the first hinge end to a coupler that removably couples to the hinge end of the second portion, the biasing assembly creating a biasing force on the flexible hinge from the first hinge end toward the first distal end and an extent of the flexible hinge exposed at the first hinge end is determined by an angular orientation of the first and second portions.

Another example can include any of the above and/or below examples where the range of angular orientations comprises from a zero-degree orientation to a 360-degree orientation, and wherein the zero-degree orientation comprises the first surface against the third surface and the 360-degree orientation comprises the second surface against the fourth surface.

Another example can include any of the above and/or below examples where the biasing assembly is configured to cause an extent of the flexible hinge exposed between the first hinge end and the coupler at a given orientation to be generally uniform along a width of the flexible hinge.

Another example can include any of the above and/or below examples where the extent of the flexible hinge exposed at the first hinge end is different at the zero-degree orientation than at the 360-degree orientation.

Another example can include any of the above and/or below examples where the width of the flexible hinge is at least 75 percent of a width of the first portion, and wherein a width of the coupler is greater than the width of the flexible hinge.

Another example can include any of the above and/or below examples where the coupler includes magnets that are aligned with additional magnets in the first hinge end of the first portion when the flexible hinge is fully biased into the first portion and the coupler is positioned against the first hinge end.

Another example can include any of the above and/or below examples where when the coupler is engaging the hinge end of the second portion and the flexible hinge is fully biased into the first portion and the coupler is positioned against the first hinge end the magnets and the additional magnets provide stability that resists rotation and/or deformation of the first portion relative to forces applied to the first surface.

Another example can include any of the above and/or below examples where when the first and second portions are physically separated from one another and the flexible hinge is fully biased into the first portion and the coupler is positioned against the first hinge end the magnets and the additional magnets provide stability that hold the coupler in a fixed angular orientation.

Another example can include any of the above and/or below examples where the flexible hinge further comprises electrical conductors that extend between electronic components in the first portion and the coupler, and the hinge end of the second portion comprises a receiver that includes electrical conductors electrically coupled to electronic components of the second portion and engagement of the coupler with the receiver both mechanically couples the first portion to the second portion and electrically couples the electronic components of the first portion and the electronic components of the second portion.

Another example can include any of the above and/or below examples where the device further comprises a slot defined in the first hinge end through which the flexible hinge extends.

Another example can include any of the above and/or below examples where the coupler has a length that is greater than a length of the slot and/or the coupler has a thickness that is greater than a thickness of the slot.

Another example can include any of the above and/or below examples where the extent of the flexible hinge exposed at the first hinge end is at a minimum where the coupler is against the first hinge end the coupler is maintained between the first and second surfaces.

Another example can include a system comprising a device comprising a first portion including a first input/output device and a second portion including a second input/output device, and a hinge assembly comprising a flexible hinge that removably couples the first and second portions and allows relative rotation between the first and second portions, the flexible hinge biased into the first portion to reduce a percentage of the flexible hinge exposed between the first and second portions at a given angular orientation of the first and second portions.

Another example can include any of the above and/or below examples where the flexible hinge terminates in a coupler that electrically and mechanically couples to a receiver on the second portion.

Another example can include any of the above and/or below examples where the device further comprises a biasing assembly positioned in the first portion that is configured to impart a bias on the flexible hinge into the first portion.

Another example can include any of the above and/or below examples where the first portion comprises first and second spaced-apart surfaces and a hinge end that extends therebetween, and further comprising a slot defined in the hinge end through which the flexible hinge extends from between the first and second spaced-apart surfaces.

Another example can include any of the above and/or below examples where an extent that the flexible hinge extends through the slot is determined by the angular orientation of the first and second portions.

Another example can include any of the above and/or below examples where the flexible hinge terminates in a coupler that is biased against the hinge end unless the bias is overcome by an external force created by the angular orientation of the first and second portions.

Another example can include any of the above and/or below examples where the first input/output device is a keyboard and the second input/output device is a display or wherein the first input/output device is a touch display and the second input/output device is a touch display.

Another example can include a system comprising a device comprising a first portion including a first input/output device and a second portion including a second input/output device, and a flexible hinge biased into the first portion and extending out of a hinge end of the first portion and terminating in a coupler that removably couples to a hinge end of the second portion and relative proportions of the flexible hinge retracted into the first portion compared to extended out of the first portion are determined in part by an angular orientation of the first and second portions.

Although techniques, methods, devices, systems, etc., pertaining to biased flexible hinges are described in language specific to structural features and/or methodological acts, it is to be understood that the subject matter defined in the appended claims is not limited to the specific features or acts described. Rather, the specific features and acts are disclosed as example forms of implementing the claimed methods, devices, systems, etc.

1. A device, comprising:
a first portion including first and second spaced-apart surfaces extending from a first hinge end to a first distal end;
a second portion including third and fourth spaced-apart surfaces extending from a second hinge end to a second distal end;
a biasing assembly positioned in the first portion between the first and second spaced-apart surfaces; and,
a flexible hinge that rotatably secures the first and second portions through a range of angular orientations, the flexible hinge secured to the biasing assembly between the first and second spaced-apart surfaces and extending out of the first hinge end to a coupler that removably couples to the hinge end of the second portion, the biasing assembly creating a biasing force on the flexible hinge from the first hinge end toward the first distal end and an extent of the flexible hinge exposed at the first hinge end is determined by an angular orientation of the first and second portions.

2. The device of claim 1, wherein the range of angular orientations comprises from a zero-degree orientation to a 360-degree orientation, and wherein the zero-degree orientation comprises the first surface against the third surface and the 360-degree orientation comprises the second surface against the fourth surface.

3. The device of claim 2, wherein the biasing assembly is configured to cause an extent of the flexible hinge exposed between the first hinge end and the coupler at a given orientation to be generally uniform along a width of the flexible hinge.

4. The device of claim 3, wherein the extent of the flexible hinge exposed at the first hinge end is different at the zero-degree orientation than at the 360-degree orientation.

5. The device of claim 4, wherein the width of the flexible hinge is at least 75 percent of a width of the first portion, and wherein a width of the coupler is greater than the width of the flexible hinge.

6. The device of claim 5, wherein the coupler includes magnets that are aligned with additional magnets in the first hinge end of the first portion when the flexible hinge is fully biased into the first portion and the coupler is positioned against the first hinge end.

7. The device of claim 6, wherein when the coupler is engaging the hinge end of the second portion and the flexible hinge is fully biased into the first portion and the coupler is positioned against the first hinge end the magnets and the additional magnets provide stability that resists rotation and/or deformation of the first portion relative to forces applied to the first surface.

8. The device of claim 6, wherein when the first and second portions are physically separated from one another and the flexible hinge is fully biased into the first portion and the coupler is positioned against the first hinge end the magnets and the additional magnets provide stability that hold the coupler in a fixed angular orientation.

9. The device of claim 6, wherein the flexible hinge further comprises electrical conductors that extend between electronic components in the first portion and the coupler, and the hinge end of the second portion comprises a receiver that includes electrical conductors electrically coupled to electronic components of the second portion and engagement of the coupler with the receiver both mechanically couples the first portion to the second portion and electrically couples the electronic components of the first portion and the electronic components of the second portion.

10. The device of claim 6, further comprising a slot defined in the first hinge end through which the flexible hinge extends.

11. The device of claim 10, wherein the coupler has a length that is greater than a length of the slot and/or the coupler has a thickness that is greater than a thickness of the slot.

12. The device of claim 11, wherein the extent of the flexible hinge exposed at the first hinge end is at a minimum where the coupler is against the first hinge end the coupler is maintained between the first and second surfaces.

13. A device, comprising:
a first portion including a first input/output device and a second portion including a second input/output device; and,
a hinge assembly comprising a flexible hinge that removably couples the first and second portions and allows relative rotation between the first and second portions, the flexible hinge biased into the first portion to reduce a percentage of the flexible hinge exposed between the first and second portions at a given angular orientation of the first and second portions.

14. The device of claim 13, wherein the flexible hinge terminates in a coupler that electrically and mechanically couples to a receiver on the second portion.

15. The device of claim 13, further comprising a biasing assembly positioned in the first portion that is configured to impart bias on the flexible hinge into the first portion.

16. The device of claim 13, wherein the first portion comprises first and second spaced-apart surfaces and a hinge end that extends therebetween, and further comprising a slot defined in the hinge end through which the flexible hinge extends from between the first and second spaced-apart surfaces.

17. The device of claim 16, wherein an extent that the flexible hinge extends through the slot is determined by the angular orientation of the first and second portions.

18. The device of claim 17, wherein the flexible hinge terminates in a coupler that is biased against the hinge end unless the bias is overcome by an external force created by the angular orientation of the first and second portions.

19. The device of claim 13, wherein the first input/output device is a keyboard and the second input/output device is a display or wherein the first input/output device is a touch display and the second input/output device is a touch display.

20. A device, comprising:
a first portion including a first input/output device and a second portion including a second input/output device; and,
a flexible hinge biased into the first portion and extending out of a hinge end of the first portion and terminating in a coupler that removably couples to a hinge end of the second portion and relative proportions of the flexible hinge retracted into the first portion compared to extended out of the first portion are determined in part by an angular orientation of the first and second portions.
